(19) United States
(12) Patent Application Publication
(10) Pub. No.: US 2026/0093369 A1
(43) Pub. Date: Apr. 2, 2026

(54) Adaptive State Control for Short-Range Communication Assemblies

(71) Applicant: ZEBRA TECHNOLOGIES CORPORATION, Lincolnshire, IL (US)

(72) Inventors: Marek Trusinski, Kings Park, NY (US); Yi Wei, St. James, NY (US); Rohan Chopra, Syosset, NY (US)

(21) Appl. No.: 18/900,124

(22) Filed: Sep. 27, 2024

(51) Int. Cl. G06F 3/046; G06F 3/042; G06F 18/25

(52) U.S. Cl. CPC G06F 3/046; G06F 3/042; G06F 18/25

(57) ABSTRACT

A method in a computing device includes: setting, at a controller of the computing device, an antenna of a short-range wireless communication assembly to a first state; obtaining, at the controller, sensor data associated with an object adjacent to the computing device; determining at the controller, whether the sensor data satisfies a criterion indicating that the object is a short-range communication device; and when the sensor data satisfies the criterion, setting the antenna to a second state.

### BACKGROUND

Computing devices, such as mobile computers, may be provided with a near-field communication (NFC) antenna, e.g., for emulating payment cards and/or implementing point-of-sale functionality. Operation of the antenna may, however, consume sufficient power to negatively impact device performance, e.g., by reducing battery life.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a computing device.

FIG. 2 is a flowchart of a method for adaptive state control for short-range communication assemblies.

FIG. 3 is a diagram illustrating an example performance of blocks 210 and 215 of the method of FIG. 2.

FIG. 4 is a diagram illustrating another example performance of blocks 210 and 215 of the method of FIG. 2.

FIG. 5 is a diagram illustrating another example performance of blocks 210 and 215 of the method of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a computing device, the method including: setting, at a controller of the computing device, an antenna of a short-range wireless communication assembly to a first state; obtaining, at the controller, sensor data associated with an object adjacent to the computing device; determining at the controller, whether the sensor data satisfies a criterion indicating that the object is a short-range communication device; and when the sensor data satisfies the criterion, setting the antenna to a second state.

Additional examples disclosed herein are directed to a computing device, comprising: a short-range wireless communication assembly including an antenna; a sensor; and a processor configured to: set the antenna to a first state; obtain, from the sensor, sensor data associated with an object adjacent to the computing device; determine whether the sensor data satisfies a criterion indicating that the object is a short-range communication device; and when the sensor data satisfies the criterion, set the antenna to a second state.

Further examples disclosed herein are directed to a method in a computing device, the method including: activating a rear-facing antenna of a short-range wireless communication assembly; obtaining, at a controller of the computing device, sensor data associated with an object adjacent to the computing device; determining, at the controller, whether the sensor data satisfies a criterion indicating that the object is a short-range communication device; and when the sensor data satisfies the criterion, disabling the antenna.

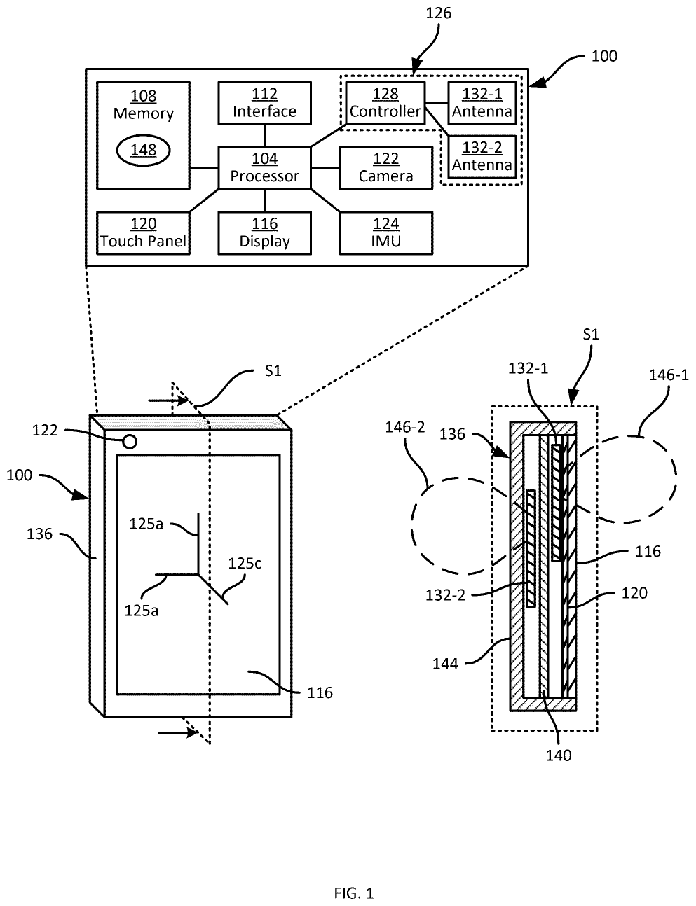

FIG. 1 illustrates a computing device 100, such as a mobile computer, smart phone, or the like. The device 100 can be implemented in a wide variety of other form factors, including a tablet computer, a laptop computer, a barcode scanner, a radiofrequency identification (RFID) reader, and the like.

Certain internal components of the device 100 are illustrated in FIG. 1. The device 100 includes a processor 104, such as a central processing unit (CPU), graphics processing unit (GPU) or the like, connected with a non-transitory computer readable medium such as a memory 108. The processor 104 and the memory 108 are implemented as one or more integrated circuits (ICs). The device 100 also includes a communication interface 112 enabling communication between the device 100 and other computing devices, via suitable wired and/or wireless links, including any suitable combination of local-area networks, wide-area networks, and peer-to-peer links.

The device 100 further includes a display 116, such as an organic light-emitting diode (OLED)-based display panel or other suitable panel. The display 116 is controllable by the processor 104 to present information, e.g., for viewing by an operator of the device 100. The device 100 can also include other output devices (e.g., devices configured to generate output perceptible by the operator of the device 100) in some examples, such as a speaker, a motor for haptic output, and the like. The device 100 further includes one or more input devices, including a touch panel 120. The touch panel 120 can include a capacitive panel integrated with the display 116, in some examples. Other forms of touch panel, such as a resistive panel, can be used in other examples. As will be apparent to those skilled in the art, the touch panel 120 can include a sensor grid that monitors changes in capacitance between layers of the panel 120 at each of a plurality of positions (e.g., tens of thousands of measurement points arranged in a grid over the display 116). Based on the magnitude and arrangement of capacitance changes reported by the grid, the processor 104 (or a controller integrated with the touch panel 120) can detect touch inputs.

The device 100 can include other inputs, including for example a camera 122 including a suitable image sensor and associated optical assembly (e.g., one or more lenses, shutters, and the like) configured to capture images, e.g., color images. The camera 122 can be disposed on a front of the device 100, e.g., on the same side of the device 100 as the display 116, such that a field of view of the camera 122 is directed towards objects on the same side of the device 100 as the display 116.

The device 100 can also include, in some examples, further inputs such as an inertial measurement unit (IMU) 124 having one or more accelerometers and/or gyroscopes. The IMU 124 can generate data representing physical movement of the device 100, e.g., including the orientation of the device 100 relative to the position shown in FIG. 1. For example, the IMU 124 can be configured to periodically (e.g., at a frequency of 30 Hz, although it will be understood that any of a wide variety of other IMU update frequencies can also be implemented) generate orientation data including a roll angle about an axis 125a, a pitch angle about an axis 125b, and a yaw angle about an axis 125c, indicating the current orientation of the device 100.

The device 100 can include further inputs in some examples, such as a magnetic proximity sensor (e.g., a Hall effect sensor, an inductive sensor, or the like) configured to generate a signal whose magnitude indicates the proximity to the device 100 of another conductive object.

The device 100 also includes a short-range wireless communication assembly 126, such as a near-field communication (NFC) assembly, or the like. The short-range wireless communication assembly 126 is configured to facilitate short-range (e.g., over distances of less than about 10 cm) exchange of information between the device 100 and other devices such as payment terminals, other mobile computers, payment cards, or the like. For example, the device 100 can emulate a payment card via the assembly 126, and provide payment data to another computing device such as a payment terminal. The device 100 can also collect payment data, e.g., from payment cards or other devices emulating payment cards.

The assembly 126 includes a controller 128, and at least one antenna. In the illustrated example, the assembly 126 includes a first antenna 132-1, and a second antenna 132-2, which are also referred to collectively herein as the antennas 132, and generically as an antenna 132. Similar nomenclature may be used elsewhere below, for reference numbers with a common root (e.g., “132”) and hyphenated suffixes (e.g., “−1” and “−2”). In some examples, the device 100 may include only one antenna 132. In further examples, the device 100 may include more than two antennas 132. The assembly 126 can include a switching circuit to selectively connect one or the other of the antennas 132 to the controller 128, in some examples. Such as switch can be integrated with the controller 128, or implemented as a discrete component between the controller 128 and the antennas 132.

The controller 128 can be configured to transmit and receive data, via a selected one of the antennas 132, at a frequency of about 13.5 MHz. Data received via the antennas 132 can be provided to the processor 104 by the controller 128, and data can be received at the controller 128 from the processor 104, for transmission via the antenna 132. The controller 128 can be implemented as a field-programmable gate array (FPGA), and application-specific integrated circuit (ASIC), or the like. In some examples, the controller 128 can be implemented by the processor 104 (e.g., as a dedicated hardware portion of the processor 104, or in software). As will be apparent, the device 100 also includes various other components, e.g., including an internal battery to supply power to the components shown in FIG. 1.

The components of the device 100 can be supported by a housing 136. For example, as shown in the cross section S1 (simplified for illustrative purposes), the housing 136 can support the display 116 and the touch panel 120 on one side of the device 100 (e.g., the front of the device 100). An interior of the device 100 enclosed by the housing 136 and the display 116 can contain the other components of the device 100. For example, the device 100 can include a main board 140 such as a printed circuit board (PCB), or a plurality of PCBs, carrying the processor 104, memory 108, and communication interface 112. The board 140 can also carry the controller 128 in some examples.

The antenna 132-1, in this example, is disposed “behind” the display 116, e.g., between the display 116 and the main board 140. The antenna 132-1 can be configured to radiate through the display 116, rather than away from the display 116 through a back 144 of the housing 136. The antenna 132-1 may therefore be referred to as forward-facing. As shown in the cross section S1, a main radiation lobe 146-1 of the antenna 132-1 is directed through the display 116, substantially perpendicular to the plane of the display 116. A main radiation lobe 146-2 of the antenna 132-2 is directed through the back 144 of the housing 136, substantially perpendicular to the back 144. The antenna 132-2 may therefore be referred to as rear-facing. The radiation patterns of the antennas 132-1 and 132-2 can be directed in substantially opposite directions, e.g., at an angle of about 180 degrees. In other examples, the antenna 132-2 can have a radiation pattern that is angled at less than 180 degrees from that of the antenna 132-1. For example, the radiation pattern of the antenna 132-2 can be angled at least 45 degrees relative to that of the antenna 132-1. The antenna 132-2 is disposed between the back 144 of the housing 136 and the main board 140, and can be configured to radiate through the back 144 instead of through the display 116. In other words, the antennas 132-1 and 132-2 are configured to radiate in substantially opposing directions. The antenna 132-1 may be suited for communications with other devices that are placed near the display 116, while the antenna 132-2 may be suited for communications with other devices that are placed near the back 144 of the device 100.

The controller 128 can be configured to implement a polling process to detect other devices and initiate communications with such other devices. For example, in implementations where the assembly 126 is an NFC assembly, the controller 128 can be configured to repeat a polling cycle, e.g., according to specifications established by the NFC Forum. The polling cycle can include transmitting polling signals for predetermined periods of time, and monitoring for responses to the polling signals, followed by monitoring for polling signals from other devices. For example, the assembly 126 can transmit polling signals to detect and/or receive data from nearby devices or articles implementing different NFC standards (e.g., NFC Type A, Type B, Type F or FeliCa at 424 kbit/s, Type F or FeliCa at 212 kbit/s, and the like).

Transmission of the polling signals mentioned above consumes power. In devices where the assembly 126 is persistently active, the repeated transmission of polling signals can negatively impact the battery life of the device 100. Further, in devices with two or more antennas 132, implementing the above polling cycle may lead to interference between the antennas 132, and/or may increase the complexity involved in controlling the antennas to mitigate interference. The device 100 is therefore configured, as discussed below, to implement an adaptive state control process for the antennas 132. The adaptive state control process permits the assembly 126 to enable the antenna 132-1 under certain conditions, and to disable the antenna 132-1 (or place the antenna 132-1 in a low-power state) under other conditions. When the antenna 132-1 is disabled or in a low-power state, the assembly 126 does not transmit signals via the antenna 132-1, and the power consumption of the assembly 126 can therefore be reduced.

The memory 108 stores a plurality of applications executable by the processor 104, including an NFC control application 148, whose execution by the processor 104 configures the processor 104 to implement the adaptive state control functionality mentioned above. In some examples, the functionality described below as being implemented via execution of the application 148 can be implemented by the controller 128, instead of by the processor 104. For example, the application 148 can be implemented in firmware of the controller 128. In further examples, the functionality discussed below can be shared between the processor 104 and the controller 128, e.g., with the processor 104 performing certain portions of the adaptive state control process, and the controller 128 performing the remaining portions. In other examples, the functionality of the application 148 can be implemented in a distinct hardware element, separate from the processor 104 and the controller 128, such as another ASIC, FPGA, or the like.

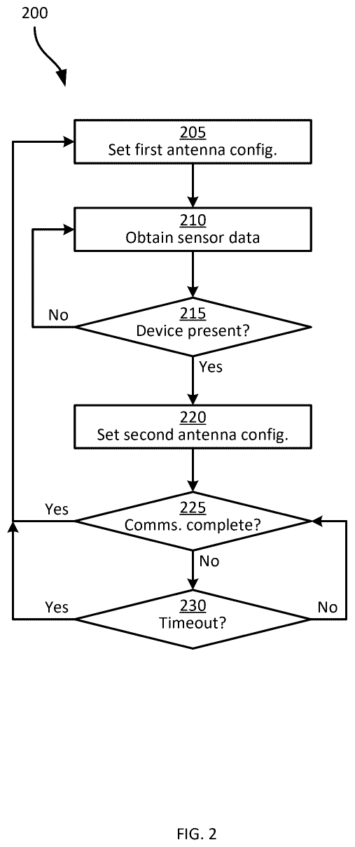

Turning to FIG. 2, a method 200 of adaptive state control for is shown. The method 200 is described below in conjunction with its performance in the device 100, and in particular by the processor 104, via execution of the application 148 (or, as noted above, by the controller 128 via execution of firmware or the like).

At block 205, the device 100 is configured to set the antenna 132-1 of the assembly 126 to a first state. Block 205 can be performed when the device 100 is powered on, and/or when the processor 104 receives input to turn on the assembly 126 (e.g., from an operator of the device 100). The first state may be a low-power state, e.g., in which the controller 128 disables power delivery to the antenna 132-1 and does not initiate the above-mentioned polling cycle or other transmissions via the antenna 132-1. In implementations including the antenna 132-2, at block 205 the antenna 132-2 may be enabled (e.g., placed in an active state). The state applied to the first antenna 132-1, along with the state applied to the second antenna 132-2, can be referred to as an antenna configuration. In some examples, setting the first state can include activating the switch mentioned earlier to connect the antenna 132-2 to the controller 128, and to disconnect the antenna 132-1 from the controller 128. In other examples, the antenna configuration at block 205 can include enabling both the antennas 132, e.g., placing both antennas in a high-power, or active, state.

At block 210, the processor 104 and/or the controller 128 is configured to obtain sensor data associated with one or more objects adjacent to the device 100. The sensor data obtained at block 210 can include data from the touch panel 120, e.g., indicating capacitance changes for each of a plurality of positions on a grid defined by the touch panel 120. As will be apparent to those skilled in the art, a change in capacitance for a given position on the touch panel 120 may indicate the presence of a nearby electrically conductive object (e.g., in contact with the display 116, or within a few centimeters of the display 116). More conductive objects, as well as smaller distances between the objects and the display 116, may result in greater changes in capacitance measured at the touch panel 120.

The sensor data obtained at block 210 can include a set of capacitance measurements from the touch panel 120, e.g., in the form of a grid of magnitude values each indicating the magnitude of a change in capacitance detected at a particular position on the touch panel 120. The sensor data obtained at block 210 can also include various other sensor data, e.g., from one or more of the camera 122, the IMU 124, a proximity sensor (e.g., a magnetic proximity sensor), or the like. Example uses of such additional sensor data are discussed further below.

At block 215, the device 100 is configured to determine whether the sensor data from block 210 satisfies a criterion indicating that an object in the vicinity of the touch panel 120 is a short-range communication device, such as another computing device, a payment card, or the like. As will be apparent to those skilled in the art, another short-range computing device, e.g., with an NFC communication assembly, also includes one or more short-range antennas, which may be implemented as coils of wire and/or circuit traces. An NFC antenna may therefore be detectable by the touch panel 120 if the NFC antenna is sufficiently close to the touch panel 120. However, various other objects can also be detected by the touch panel 120 (or more generally, can be detected from the sensor data obtained at block 210). For example, the fingers of an operator of the device 100, keys or other metallic objects stored in a pocket, purse, or the like alongside the device 100, and the like, may be represented in the sensor data from the touch panel 120.

At block 215 the device 100 therefore seeks to distinguish between sensor data that indicates the absence of any objects or the presence of objects that are unlikely to be short-range communication devices, and objects that are likely to be short-range communication devices. The device 100 can extract one or more attributes of the sensor data from block 210, and determine whether the extracted attributes satisfy one or more predetermined criteria. When the extracted attributes do not satisfy the criteria, the determination at block 215 is negative, and the device 100 returns to block 210 to obtain further sensor data. The frequency at which block 210 is repeated can vary depending on the computational resources of the processor 104 and/or the controller 128, and on the input devices (e.g., on the update frequency of the touch panel 120).

When the extracted attributes satisfy the criteria, the determination at block 215 is affirmative and the device 100 proceeds to block 220. At block 220, the device 100 is configured to set the antenna 132-1 to a second state. The second state can include supplying power to the antenna 132-1, e.g., to initiate a polling cycle for communicating with the short-range communication device detected at block 215. At block 220 the processor 104 and/or the controller 128 can also set the antenna 132-2 to the idle state, or otherwise interrupt the polling cycle at the antenna 132-2. In other words, at block 220 the device 100 can switch to an antenna configuration in which the antenna 132-1 is active, and the antenna 132-2 is idle. In other examples, the second antenna configuration can include disabling or idling the second antenna 132-2, without changing the state of the first antenna 132-1 (e.g., if the antenna 132-1 was already active in the first antenna configuration from block 205).

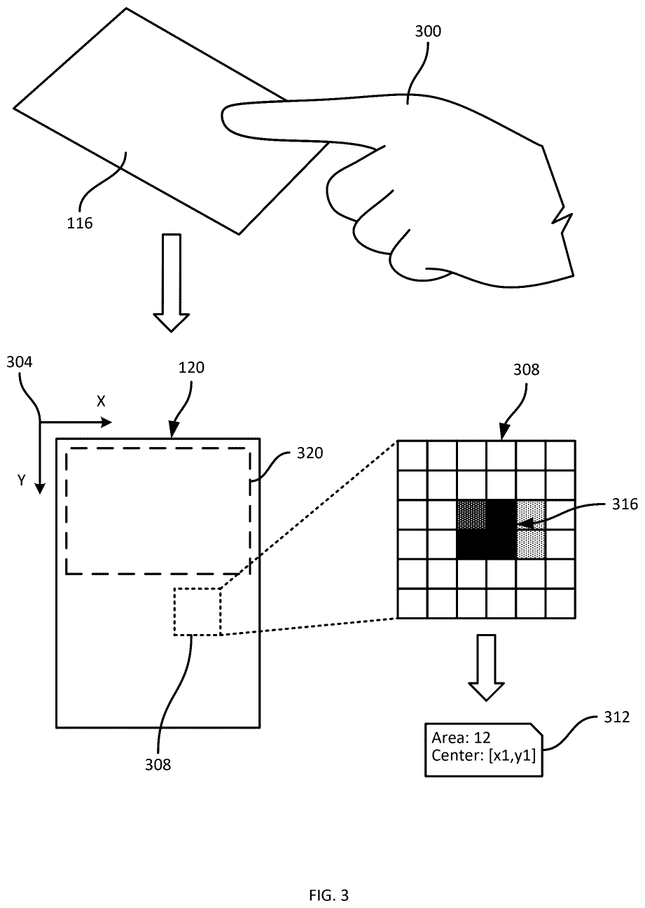

Referring to FIG. 3, an example performance of blocks 210 and 215 is illustrated. For example, as shown in the upper portion of FIG. 3, an operator 300 of the device 100 can touch the display 116. The index finger of the operator 300 may therefore be detected by the touch panel 120. The sensor data obtained at block 210 can include a grid of capacitance measurements, e.g., according to a coordinate system 304, including a region 308 corresponding to the location of the index finger of the operator 300. The magnified depiction of the region 308 illustrates the magnitude of measured capacitance changes with darker cells of the grid corresponding to greater changes in capacitance, e.g., due to a more conductive object nearby and/or an object physically closer to the touch panel 120. As will be apparent to those skilled in the art, the nature of the sensor data can vary widely, and need not include a graphical representation as shown in FIG. 3. For example, the sensor data received from the input panel 120 can include an array of numerical values in some examples.

At block 215, the device 100 can determine one or more attributes 312 from the sensor data, such as a size of a contiguous set 316 of capacitance changes above a predetermined threshold. For example, in FIG. 3, the four darkest capacitance measurements may exceed the above threshold, and the device 100 can determine a physical area of those measurements (e.g., 12 square millimeters). It will be understood that the area attribute can be replaced and/or supplemented by a count of measurements above the threshold, one or more other dimensions of those measurements, or the like. The device 100 can also determine other attributes, such as a center of the above-mentioned contiguous set, expressed in coordinates in the coordinate system 304.

The device 100 can further determine whether the attributes 312 satisfy one or more criteria at block 215. For example, the device 100 can determine whether the center of the set 316 is within a predetermined area 320 in the coordinate system 304. For example, given the placement of the antenna 132-1 behind the area 320 (as seen in FIG. 1), objects detected outside the area 320 may be less likely to be other short-range communication devices. The device 100 can also determine, for example, whether the size (or any other suitable dimension) of the set 316 exceeds a predetermined threshold (e.g., a threshold in square millimeters, selected to filter out objects such as fingertips or the like). When the set 316 is below that threshold, or when the center of the set 316 is outside the area 320, the determination at block 215 is negative.

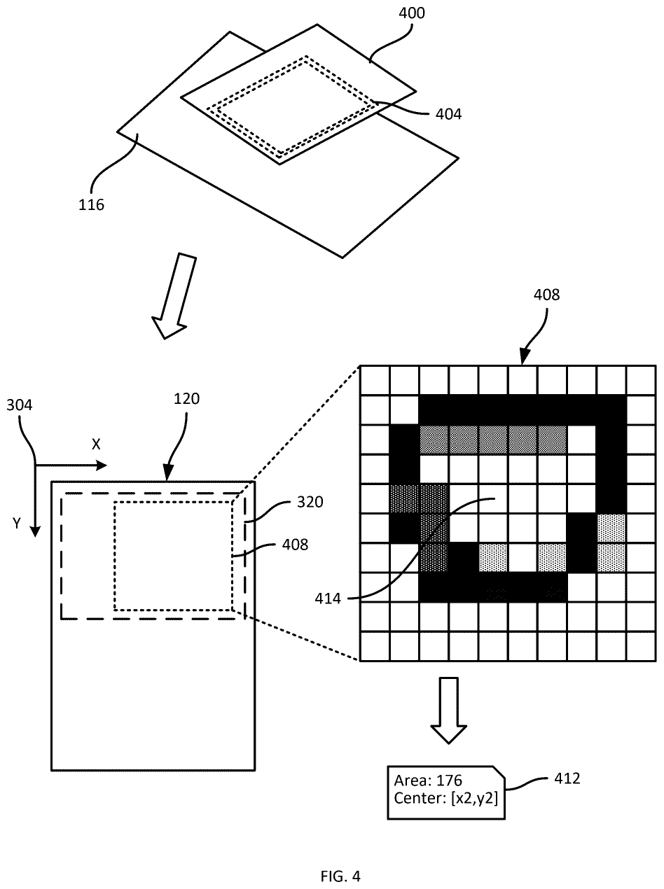

FIG. 4 illustrates another example performance of blocks 210 and 215. In FIG. 4, a device such as a payment card 400 is shown being held close to, or tapped against, the display 116. The card 400 includes an antenna 404 embedded therein, e.g., a coil of circuit traces, wire, or the like. As shown in the lower portion of FIG. 4, in response to the card 400 approaching the display 116, the processor 104 can obtain sensor data from the input panel 120 that includes capacitance measurements shown in the magnified region 408, and can determine attributes 412, such as coordinates of a center 414 of the capacitance measurements exceeding a threshold, and a size of those capacitance measurements (e.g., an area, although as noted above, other dimensions can also be determined). In this example, the center 414 is within the area 320, and the area determined at block 215 (e.g., 176 mm²) exceeds the threshold area. The determination is therefore affirmative at block 215.

Returning to FIG. 2, after applying the second antenna configuration, e.g., to set the antenna 132-1 to the second (e.g., enabled for polling) state and the antenna 132-2 to an idle or disabled state, at block 225 the device 100 is configured to determine whether a communication session with another device is complete. The communication session can include the exchange of payment information to complete a transaction, for example. The communication session can include the exchange of a wide variety of other data, in other examples. For example, the device 100 can receive from the other device, and/or send to the other device, authentication data (e.g., a device identifier, a cryptographic key, or the like), item identification data (e.g., to read an identifier from an RFID tag), and the like.

When the determination at block 225 is affirmative, the device 100 returns to block 205, to return the antenna 132-1 to the first state. When the determination at block 225 is negative, the device 100 can determiner, at block 230, whether a timeout period has elapsed since the performance of block 220. In other words, the device 100 can start a timer when the antenna 132-1 is set to the second state. The timer can be based on an expected completion time for a short-range communication such as a tag read, a payment transaction, or the like. For example, the timeout period can be between one second and five seconds (although shorter or longer periods can be implemented, in other examples). Expiry of the timeout period before a communication is complete may indicate that the detection at block 215 was a false positive, e.g., that an object represented in the sensor data from block 210 appeared likely to be a communication device, but was not a communication device. An affirmative determination at block 230 permits the device 100 to return to block 205, reducing the amount of time that the antenna 132-1 actively polls when it is unlikely that a viable target for such polling is in range. When the determination at block 230 is negative, the device 100 returns to block 225.

In further examples, as noted earlier, the device 100 can receive additional sensor data at block 210, such as one or more images from the camera 122 captured substantially simultaneously with the data from the touch panel 120. The sensor data can also include, in addition to or instead of the touch panel data and/or images, orientation data from the IMU 124 and/or sensor data from a proximity sensor. The device 100 can be configured to determine attributes from each of the above types of sensor data, and to compare those attributes with corresponding criteria. For example, the device 100 can be determine to compare the orientation of the device 100 to a predetermined range of roll, pitch, and yaw angles that are likely to indicate that the device 100 is being held against another short-range communication device. In further examples, the device 100 can detect objects in images from the camera 122, and determine sizes and/or shapes of such objects to compare with target size and/or shape ranges.

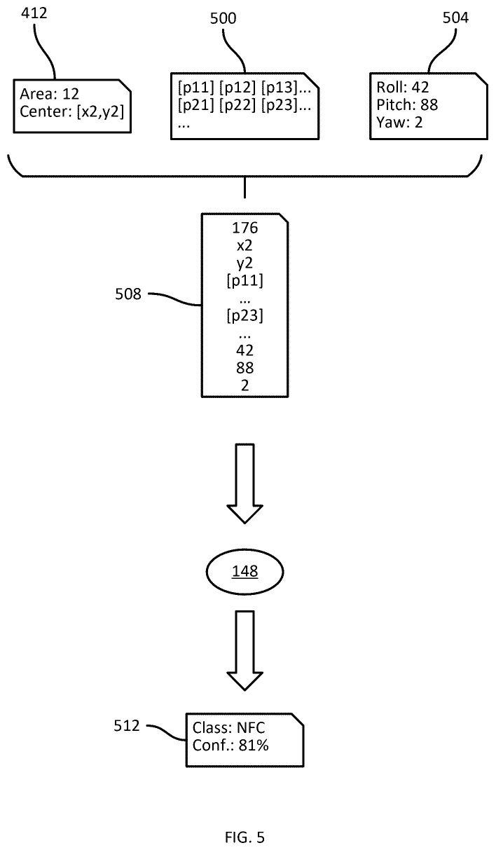

In further examples, turning to FIG. 5, the sensor data obtained at block 210 can be combined and provided to a classifier executed by the processor 104 and/or the controller 128, to determine whether the sensor data is likely indicative of a short-range communication device near the display 116. For example, as shown in FIG. 5, the device 100 can obtain the attributes 312 from touch panel data, as well as an image 500 from the camera 122, e.g., in the form of an array of pixels p11, p12, and so on. Each pixel can contain, for example, numerical values for red, green, and blue channels (or another suitable colorspace). The device 100 can also obtain, for example, orientation data 504 indicating roll, pitch, and yaw angles. The device 100 can be configured, at block 215, to execute a classifier such as a neural network trained with labelled samples of sensor data obtained with short-range communication devices near the device 100, and other labelled samples of sensor data obtained without short-range communication devices near the device 100. The classifier, e.g., implemented as a component of the application 148, can receive combined input data, e.g., in the form of a vector 508 assembled from the sensor data 412, 500, and 504, and can be configured to determine a classification 512 (e.g., “NFC” for a likely NFC device, or “other” for an object that appears unlikely to be another short-range communication device) based on the sensor data. The classification 512 can include a confidence value, e.g., expressed as a percentage in this example. The determination at block 215 can be affirmative when the class corresponds to a short-range communication device, and the confidence exceeds a predetermined threshold, for example (e.g., 75%, although the threshold can have a wide variety of other values).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . .a”, “has . . .a”, “includes . . .a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a computing device, the method comprising:
setting, at a controller of the computing device, an antenna of a short-range wireless communication assembly to a first state;
obtaining, at the controller, sensor data associated with an object adjacent to the computing device;
determining at the controller, whether the sensor data satisfies a criterion indicating that the object is a short-range communication device; and
when the sensor data satisfies the criterion, setting the antenna to a second state.

2. The method of claim 1, wherein setting the antenna to the first state includes setting the antenna to a low-power state.

3. The method of claim 2, further comprising:
when the sensor data satisfies the criterion, disabling a second antenna of the computing device.

4. The method of claim 1, wherein setting the antenna to the second state includes controlling the antenna to initiate a polling cycle for communicating with the short-range communication device.

5. The method of claim 4, further comprising:
determining that a communication with the short-range communication device is complete; and
setting the antenna to the first state.

6. The method of claim 4, further comprising:
determining that a timeout period has elapsed prior to completion of the communication with the short-range communication device is complete; and
setting the antenna to the first state.

7. The method of claim 1, wherein obtaining the sensor data includes:
determining a position and a size of an object detected by the sensor.

8. The method of claim 7, wherein determining whether the sensor data corresponds to a short-range communication device includes:
determining whether at least one of the position and the size satisfies the criterion.

9. The method of claim 7, wherein obtaining the sensor data further includes at least one of:
(i) obtaining an image from a camera of the computing device,
(ii) obtaining an orientation of the computing device from an inertial measurement unit (IMU),
(iii) obtaining a proximity measurement from a magnetic sensor.

10. The method of claim 9, wherein determining whether the sensor data corresponds to a short-range communication device includes:
executing a classifier based on the sensor data to generate a likelihood that the sensor data corresponds to the short-range communication device.

11. A computing device, comprising:
a short-range wireless communication assembly including an antenna;
a sensor; and
a processor configured to:
set the antenna to a first state;
obtain, from the sensor, sensor data associated with an object adjacent to the computing device;
determine whether the sensor data satisfies a criterion indicating that the object is a short-range communication device; and
when the sensor data satisfies the criterion, set the antenna to a second state.

12. The computing device of claim 11, wherein the processor is configured to set the antenna to the first state by setting the antenna to a low-power state.

13. The computing device of claim 12, wherein the short-range wireless communication assembly further comprises a second antenna; and
wherein the processor is configured, when the sensor data satisfies the criterion, to disable the second antenna of the computing device.

14. The computing device of claim 11, wherein the processor is configured to set the antenna to the second state by controlling the antenna to initiate a polling cycle for communicating with the short-range communication device.

15. The computing device of claim 14, wherein the processor is further configured to:
determine that a communication with the short-range communication device is complete; and
set the antenna to the first state.

16. The computing device of claim 14, wherein the processor is further configured to:
determine that a timeout period has elapsed prior to completion of the communication with the short-range communication device is complete; and
set the antenna to the first state.

17. The computing device of claim 11, wherein the sensor includes a touch panel; and
wherein the processor is configured to obtain the sensor data by:
determining a position and a size of an object detected by the touch panel.

18. The computing device of claim 17, wherein the processor is further configured to determine whether the sensor data corresponds to a short-range communication device by:
determining whether at least one of the position and the size satisfies the criterion.

19. The computing device of claim 17, wherein the processor is configured to obtain the sensor data by at least one of:
(i) obtaining an image from a camera of the computing device,
(ii) obtaining an orientation of the computing device from an inertial measurement unit (IMU), or
(iii) obtaining a proximity measurement from a magnetic sensor.

20. The computing device of claim 19, wherein the processor is configured to determine whether the sensor data corresponds to a short-range communication device by:
executing a classifier based on the sensor data to generate a likelihood that the sensor data corresponds to the short-range communication device.

21. A method in a computing device, the method comprising:
activating a rear-facing antenna of a short-range wireless communication assembly;
obtaining, at a controller of the computing device, sensor data associated with an object adjacent to the computing device;
determining, at the controller, whether the sensor data satisfies a criterion indicating that the object is a short-range communication device; and
when the sensor data satisfies the criterion, disabling the antenna.

22. The method of claim 21, further comprising:
when the sensor data satisfies the criterion, activating a forward-facing antenna of the short-range wireless communication assembly.

23. The method of claim 21, wherein the sensor data includes a position and a size of an object detected by a touch panel of the computing device.
